(19) United States
(12) Patent Application Publication
(10) Pub. No.: US 2025/0061301 A1
(43) Pub. Date: Feb. 20, 2025

(54) DEBUG METHOD IMPLEMENTED BY AN NFC DEVICE

(71) Applicant: STMicroelectronics International N.V., Geneva (CH)

(72) Inventors: Lucile MARGARIA, Saint Savournin (FR); Philippe ALARY, Puyloubier (FR); Julien MERCIER, Mimet (FR)

(73) Assignee: STMicroelectronics International N.V., Geneva (CH)

(21) Appl. No.: 18/800,891

(22) Filed: Aug. 12, 2024

(30) Foreign Application Priority Data
Aug. 17, 2023 (FR) 2308742

(51) Int. Cl. G06K 19/07

(52) U.S. Cl. CPC G06K 19/0722

(57) ABSTRACT

A debug method implemented by a first near field communication (NFC) device includes a step of storing, in a memory of the first NFC device, one or more parameters which are associated with the operation of the first NFC device during a communication with a second distant NFC device. The first NFC device then uses an answer to select (ATS) communication, sent in response to receipt of an answer to select (ATS) communication, to send the stored one or more parameters to the second distant NFC device.

### PRIORITY CLAIM

This application claims the priority benefit of French Application for Patent No. 2308742, filed on Aug. 17, 2023, the content of which is hereby incorporated by reference in its entirety to the maximum extent allowable by law.

### TECHNICAL FIELD

The present disclosure generally concerns debug methods implemented by NFC devices, as well as NFC devices and systems implementing such debug methods.

### BACKGROUND

NFC communication devices are increasingly common and equip many electronic devices and more particularly cellphones (smartphones).

NFC protocols, such as defined by the NFC forum, allow the communication between NFC devices.

However, it is now difficult to understand the origin of a problem when the NFC communication is disturbed or impossible to start.

There exists a need to implement a debug method enabling to know the conditions which result in a disturbance of the NFC communication.

There is a need in the art to overcome all or part of the disadvantages of known NFC methods and devices.

### SUMMARY

An embodiment provides a debug method implemented by a first NFC device comprising: storing, in a memory of the first NFC device, one or a plurality of parameters, associated with the operation of the first device during a communication with a second distant NFC device.

According to an embodiment, said memory is a volatile memory.

According to an embodiment, said memory is a history memory.

According to an embodiment, said memory is a non-volatile memory.

According to an embodiment, said one or a plurality of parameters are physical parameters.

According to an embodiment, said physical parameters of said one or a plurality of parameters are associated with a value of an electromagnetic field received by the first device.

According to an embodiment, said one or a plurality of parameters associated with the operation of the first device are associated with a configuration state of the first device.

According to an embodiment, said configuration state is selected from among a clock state, an end-of-frame time, and a time sequence.

According to an embodiment, the method comprises: extracting from said memory said one or a plurality of parameters associated with the operation of the first device after the reception of a request sent by the second distant device.

According to an embodiment, said one or a plurality of extracted parameters are transmitted to the second device in an ATS frame.

An embodiment provides an NFC device comprising one or a plurality of circuits configured to determine one or a plurality of parameters associated with the operation of the NFC device during a communication with a second distant NFC device; the NFC device being configured to implement the method such as described hereabove.

According to an embodiment, said one or a plurality of circuits configured to determine one or a plurality of parameters associated with the operation of the first NFC device are selected from among a sensor delivering data relative to an electromagnetic field originating from the second distant NFC device and a register configured to record an alert.

An embodiment provides a system comprising: a first NFC device such as described hereabove; and a second NFC device, distant from the first NFC device.

According to an embodiment, the system comprises a device configured to capture the content of a communication between the first NFC device and the second NFC device and to extract therefrom one or a plurality of parameters associated with the operation of the first NFC device.

An embodiment provides a method of debugging a system such as described hereabove and comprising: capturing the content of a communication between a first and a second NFC device with a device configured to capture the content of a communication between the first and the second NFC devices; and extracting said one or a plurality of operating parameters associated with the operation of said first NFC device during the communication based on the captured content.

### BRIEF DESCRIPTION OF THE DRAWINGS

The foregoing features and advantages, as well as others, will be described in detail in the rest of the disclosure of specific embodiments given by way of illustration and not limitation with reference to the accompanying drawings, in which:

FIG. 1 shows a simplified view of an example of a NFC communication system;

FIG. 2 shows a method of debugging the NFC communication system of FIG. 1; and

FIG. 3 shows an example of communication of the NFC communication system of FIG. 1.

### DETAILED DESCRIPTION

Like features have been designated by like references in the various figures. In particular, the structural and/or functional features that are common among the various embodiments may have the same references and may dispose identical structural, dimensional and material properties.

For the sake of clarity, only the steps and elements that are useful for the understanding of the described embodiments have been illustrated and described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, when reference is made to terms qualifying absolute positions, such as terms “edge”, “back”, “top”, “bottom”, “left”, “right”, etc., or relative positions, such as terms “above”, “under”, “upper”, “lower”, etc., or to terms qualifying directions, such as terms “horizontal”, “vertical”, etc., it is referred, unless specified otherwise, to the orientation of the drawings.

Unless specified otherwise, the expressions “about”, “approximately”, “substantially”, and “in the order of” signify plus or minus 10%, preferably of plus or minus 5%.

Systems of NFC communication or in other words in near field use a radio frequency electromagnetic field generated by a device (terminal or reader) to communicate with another device (card). A same device may, particularly in the case of cell phones, operate in reader mode by generating a field intended for another device, or in card emulation mode by capturing a field generated by another device. This technology concerns the completion of communications at very short distance (shorter than some ten centimeters) between two devices. The applications of the NFC system are for example secure payments or transport cards, for example.

In the present disclosure, the case of a system where the NFC devices are compatible with the NFC technology according to the NFC Forum is considered.

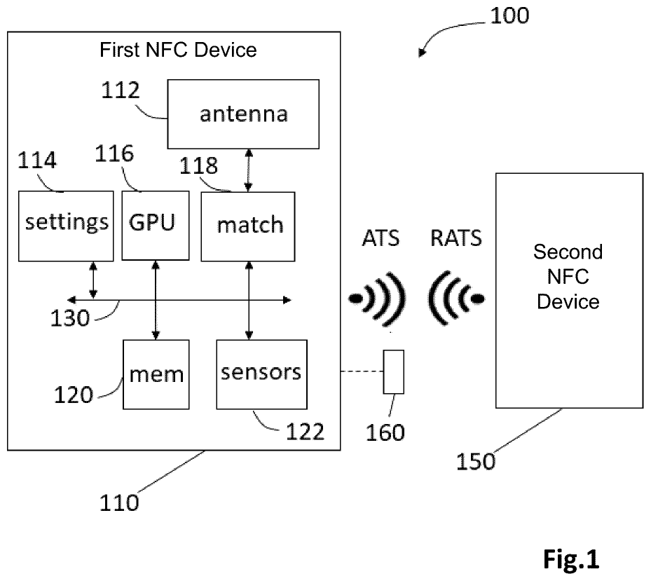

FIG. 1 shows a simplified view of an example of an NFC communication system 100.

NFC communication system 100 comprises a first distant NFC device 110 and a second distant NFC device 150.

First NFC device 110 comprises an antenna 112 coupled, preferably connected, to an impedance matching circuit 118 (match). First NFC device 110 comprises, for example, an NFC controller 116 (GPU) comprising one or a plurality of processors under control of instructions stored in a system instruction memory, not shown. First NFC device 110 comprises, for example, one or a plurality of volatile or non-volatile memories 120 (mem) as well as one or a plurality of physical parameter sensors 122 (sensors) and an area of storage of modifiable elements 114 of configuration (settings) of first NFC device 110. One or a plurality of system buses 130, data, addresses, and control signals, are used for the exchange of control signals between, for example, NFC controller 116 (GPU), the or the plurality of volatile or non-volatile memories 120 (mem), the or the plurality of physical parameter sensors 122, and setting storage area 114.

Device 100 may further integrate other circuits implementing other functions (for example, one or a plurality of volatile and/or non-volatile memories, other processing units), not shown in FIG. 1. Among these other circuits, device 100 comprises, for example, a read-only or static memory of ROM type.

Sensors 122 are, for example, configured to capture an electromagnetic field value at the level of first NFC device 110 during a communication with second NFC device 150. In another example, an image of the value of the generated current is given by this or these sensors with a greater or lower accuracy.

Settings 114 are, for example, modifiable by the user and concern, for example, a clock state and/or a time sequence of device 110. The time sequence is, for example, an answer time interval. Settings 114 are, for example, coded in one or a plurality of registers.

The first and the second NFC device communicate via electromagnetic fields. When second device 150 is in so-called reader mode, it emits an electromagnetic field and if the first NFC device 110 is in a so-called card emulation mode, and passes in this field, the captured energy enables it to be powered and to answer the requests sent by second NFC device 150.

Among the possible requests sent by second device 150 in reader mode, there exists a request called Request Answer To Select (RATS) request. This RATS request calls for an answer from a portion of first NFC device 110 that is referred to as an Answer To Select (ATS). This ATS answer comprises data which do not change, in other words data which are non-dynamic or non-modifiable during the lifetime of the product, such as the identity of NFC device 110 for example.

In the shown example, a sniff device 160 is configured to capture the content of a communication between first circuit NFC 110 and second circuit NFC 150. Sniff device 160 enables to extract data sent by first NFC device 110 based on the captured content.

In the case of a defective communication, it is now difficult to have access to the environmental and operating parameters of first NFC device 110 which have resulted in a malfunction since these parameters are not stored and transmitted and since, often, the environmental parameters change rapidly. The debugging of such situations is thus difficult and expensive.

The described embodiments provide a debug method, implemented by first NFC device 110, and comprising a step consisting of storing, in a memory of first NFC device 110, one or a plurality of parameters, associated with the operation of the first device during a communication, for example the last one, with the second distant NFC device 150.

An advantage of these embodiments lies in the fact that the access to the operating parameters of NFC device 110, which were present during the communication, is eased since they are stored and thus more easily found. The resolution of problems linked to the communication between NFC devices is thus improved.

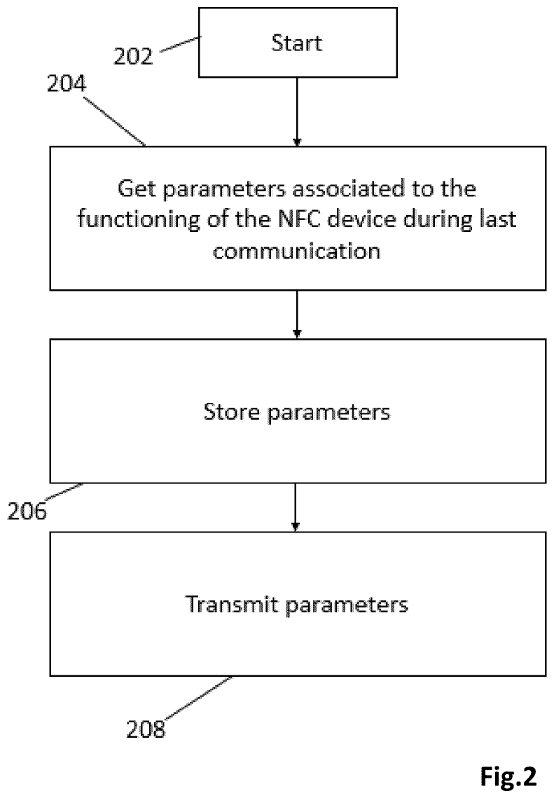

FIG. 2 shows a method of debugging the NFC communication system of FIG. 1.

In a first step 202 (Start) the method starts.

In a subsequent step 204 (Get parameters associated to the functioning of the NFC device during last communication), the operating parameters of the last communication between the first and the second NFC devices 110, 150 are determined. These are, for example, physical parameters originating from the or the plurality of sensors 122 and/or, for example, from configuration parameters 114 selected by the user.

In a subsequent step 206 (Store parameters), the operating parameters of the last communication are stored, for example in memory 120, which is, for example, volatile or non-volatile.

In an optional subsequent step 208 (Transmit parameters), the stored operating parameters of the last communication are transmitted in the ATS answer as a response to the RATS request by second NFC device 150. In an example, the stored operating parameters of the last communication are transmitted in a library called RFlib of the ATS answer. After reception by device 160 or second NFC device 150, it is possible to extract the operating parameters present during the last communication.

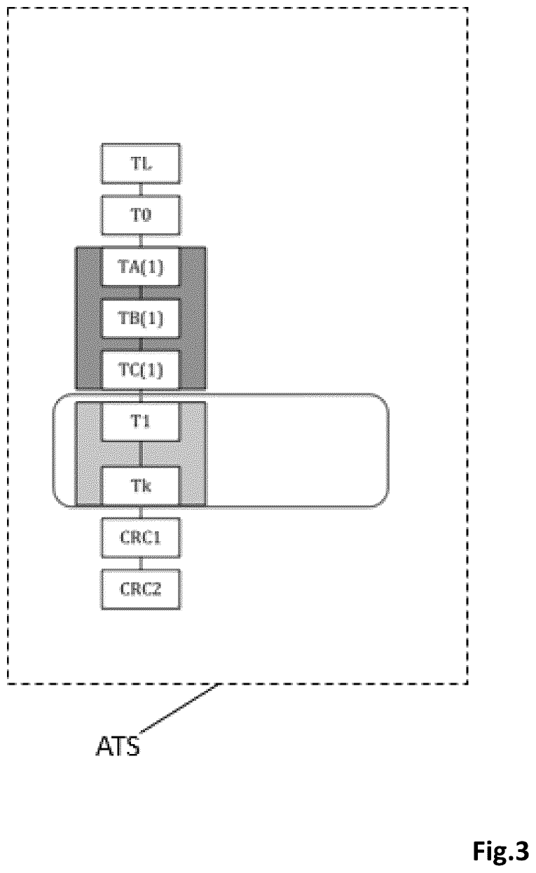

FIG. 3 shows an example of communication of the NFC communication system of FIG. 1.

More particularly, the shown example illustrates the storage library RFlib used in particular in the ATS answer frame of first NFC device 110.

The shown library RFlib comprises data, for example organized in registers, TL, TO, TA(1), TB(1), TC(1), T1, . . . , Tk, CRC1, CRC2. Data TL correspond, for example, to a byte length. Data T0 correspond to a data format. Data TA(1), TB(1), and TC(1) correspond to interface bytes, such as for example modifiable user settings, codes called DS and DR, codes called frame waiting time integer (FWI) and start-up frame guard time (SFGI), and eventually protocol option codes. Data CRC1 and CRC2 are cyclic redundancy codes used for error detection. Data T1, . . . , Tk correspond to a register storage of historical bytes (reference is made to ISO/IEC 7816-4:2020, incorporated by reference, for the definition of a historical byte register in this context). In an example, these historical memory bytes are used to show, in other words to store, parameters associated with the operation of device 110 during the last communication which is desired to be used for the method of debugging the communication which has been disturbed. These parameters vary over time according to the environment or according to the proximity or to the type of second device 150, in other words the parameters stored in the library are dynamic or modifiable during the lifetime of the product. In an example, T1 shows a configuration state of first device 110, for example an end-of-frame time (EOF). In another example, T2, T3, and T4 show an image of the electromagnetic field or image of the current induced at the level of device 110 during the last communication and this, with more or less accuracy (T2 more accurate than T3 and T4 for example). The parameters associated with the operation of device 110 during the last communication are stored, for example, in registers linked to address T1 to Tk. The use of historical bytes to represent, or temporarily or non-volatilely store the parameters associated with the operation of device 110 during the last communication, enables not to modify the arrangement of the frames defined by the NFC protocol while integrating therein data useful to the debugging.

When the communication is interrupted or disturbed, it is then possible, with device 160 for example, to trace back the parameters associated with the operation of first NFC device 110 during the last communication by analyzing the ATS frame.

Various embodiments and variants have been described. Those skilled in the art will understand that certain features of these various embodiments and variants may be combined, and other variants will occur to those skilled in the art. In particular, regarding the storage of the parameters associated with the operation of device 110 during the last communication, it can be envisaged to store these parameters both in a non-volatile memory and in the historical bytes of the ATS frame.

Finally, the practical implementation of the described embodiments and variants is within the abilities of those skilled in the art based on the functional indications given hereabove. In particular, the parameters associated with the operation of first NFC device 110 during the last communication may be stored in other libraries, other than library RFlib and the historical bytes and possibly transmitted in another frame than the ATS frame. Further, it is possible to consider storing the parameters associated with the operation which are of any kind such as other physical parameters, for example a humidity rate or data relative to the time at which the last transaction has occurred. It may further be envisaged to store operating parameters of device 110 during communications or transactions subsequent to the last communication.

1. A debug method implemented by a first near field communication (NFC) device, comprising:
storing, in a memory of the first NFC device, one or a plurality of parameters associated with the operation of the first NFC device during a communication with a second distant NFC device.

2. The method according to claim 1, wherein said memory is a volatile memory.

3. The method according to claim 2, wherein said memory includes a historical byte register storing said one or a plurality of parameters.

4. The method according to claim 1, wherein said memory is a non-volatile memory.

5. The method according to claim 1, wherein said one or a plurality of parameters are physical parameters.

6. The method according to claim 5, wherein said physical parameters of said one or a plurality of parameters are associated with a value of an electromagnetic field received by the first NFC device.

7. The method according to claim 1, wherein said one or a plurality of parameters associated with the operation of the first NFC device are associated with a configuration state of the first NFC device.

8. The method according to claim 7, wherein said configuration state is selected from among a clock state, an end-of-frame time, and a time sequence.

9. The method according to claim 1, further comprising:
extracting from said memory said one or a plurality of parameters associated with the operation of the first NFC device after the reception of a request sent by the second distant NFC device.

10. The method according to claim 9, further comprising transmitting said one or a plurality of parameters extracted from the memory to the second NFC device in an Answer To Select (ATS) frame.

11. A near field communication (NFC) device, comprising:
one or a plurality of circuits configured to determine one or a plurality of parameters associated with the operation of the NFC device during a communication with a second distant NFC device;
wherein the NFC device is configured to implement the method according to claim 1.

12. The NFC device according to claim 11, wherein said one or a plurality of circuits configured to determine one or a plurality of parameters associated with the operation of the first NFC device are selected from among: a sensor delivering data relative to an electromagnetic field originating from the second distant NFC device and a register configured to record an alert.

13. A system, comprising:
a first NFC device according to claim 11;
a second NFC device, distant from the first NFC device.

14. The system according to claim 13, further comprising a sniff device configured to capture the content of a communication between the first NFC device and the second NFC device and extract therefrom one or a plurality of parameters associated with the operation of the first NFC device.

15. A method of debugging a system according to claim 14, comprising:
capturing the content of a communication between a first near field communication (NFC) device and a second NFC device with the sniff device configured to capture the content of a communication between the first and the second NFC devices; and
extracting said one or a plurality of operating parameters associated with the operation of said first NFC device during the communication based on the captured content.

16. A debug method implemented by a first near field communication (NFC) device, comprising:
storing, in a memory of the first NFC device, an end-of-frame time (EOF) parameter used by the first NFC device in connection with a communication with a second NFC device; and
transmitting the stored EOF parameter from the memory of the first NFC device to the second NFC device in an answer to select (ATS) communication sent by the first NFC device in response to a request answer to select (RATS) communication sent by the second NFC device;
wherein a frame of said ARS communication includes a field linked to a location in the memory where the EOF parameter is stored.

17. A debug method implemented by a first near field communication (NFC) device, comprising:
storing, in a memory of the first NFC device, an image of an electromagnetic field associated with a communication between the first NFC device and a second NFC device; and
transmitting the stored image of the electromagnetic field from the memory of the first NFC device to the second NFC device in an answer to select (ATS) communication sent by the first NFC device in response to a request answer to select (RATS) communication sent by the second NFC device;
wherein a frame of said ARS communication includes a field linked to a location in the memory where the image of the electromagnetic field is stored.

18. A debug method implemented by a first near field communication (NFC) device, comprising:
storing, in a memory of the first NFC device, an image of the current induced at the first NFC device during a communication with a second NFC device; and
transmitting the image of the current from the memory of the first NFC device to the second NFC device in an answer to select (ATS) communication sent by the first NFC device in response to a request answer to select (RATS) communication sent by the second NFC device;
wherein a frame of said ARS communication includes a field linked to a location in the memory where the image of the current is stored.
